(19) United States
(12) Patent Application Publication
(10) Pub. No.: US 2024/0302901 A1
(43) Pub. Date: Sep. 12, 2024

(54) VIRTUAL HAPTIC TEXTURE RENDERING METHOD AND DEVICE, DISPLAY DEVICE, AND STORAGE MEDIUM

(71) Applicants: Beijing BOE Technology Development Co., Ltd., Beijing (CN); BOE TECHNOLOGY GROUP CO., LTD., Beijing (CN)

(72) Inventor: Yuju Chen, Beijing (CN)

(73) Assignees: Beijing BOE Technology Development Co., Ltd., Beijing (CN); BOE TECHNOLOGY GROUP CO., LTD., Beijing (CN)

(21) Appl. No.: 18/665,976

(22) Filed: May 16, 2024

Related U.S. Application Data
(63) Continuation of application No. PCT/CN2023/080764, filed on Mar. 10, 2023.

(51) Int. Cl. G06F 3/01; G06F 3/041; G06T 11/00

(52) U.S. Cl. CPC G06F 3/016; G06F 3/041; G06T 11/001

(57) ABSTRACT

The present disclosure provides a virtual haptic texture rendering method, a virtual haptic texture rendering device, a display device, and a storage medium. The method includes: obtaining a to-be-displayed visual image; converting the visual image into a grayscale image; performing multi-valued processing on the grayscale image to obtain a haptic response image, all pixels of the haptic response image being grouped into at least two grayscale regions, and different haptic parameters corresponding to different grayscale regions; and associating a first coordinate system of the visual image with a second coordinate system of the haptic response image to obtain an association relationship between the first coordinate system and the second coordinate system.

### CROSS-REFERENCE TO RELATED APPLICATIONS

This application is a continuation application of the PCT application No. PCT/CN2023/080764 filed on Mar. 10, 2023, which is incorporated herein by reference in its entirety.

### TECHNICAL FIELD

The present disclosure relates to the field of virtual haptic technology, in particular to a virtual haptic texture rendering method, a virtual haptic texture rendering device, a display device, and a storage medium.

### BACKGROUND

Haptic rendering is a cutting-edge technology in the field of virtual reality and human-computer interaction. Haptic rendering allows a user to perceive a shape, texture and other characteristics of a displayed object through touch, so as to push the communication between the user and virtual world to a new stage where hearing, vision and touch are fused. Multimedia terminals with a haptic rendering function have broad application prospects in the fields of education, entertainment and medical treatment, and the high realistic haptic rendering technology has been a challenging problem in the field of human-computer interaction.

### SUMMARY

An object of the present disclosure is to provide a virtual haptic texture rendering method, a virtual haptic texture rendering device, a display device, and a storage medium, so as to realize high realistic haptic rendering.

In order to solve the above-mentioned technical problem, the present disclosure provides the following technical solutions.

In one aspect, the present disclosure provides in some embodiments a virtual haptic texture rendering method, including: obtaining a to-be-displayed visual image; converting the visual image into a grayscale image; performing multi-valued processing on the grayscale image to obtain a haptic response image, all pixels of the haptic response image being grouped into at least two grayscale regions, and different haptic parameters corresponding to different grayscale regions; and associating a first coordinate system of the visual image with a second coordinate system of the haptic response image to obtain an association relationship between the first coordinate system and the second coordinate system, the association relationship being configured to determine a haptic parameter corresponding to a pixel at a touch point of a user in the case that the visual image is displayed and touched by the user, and generate a haptic vibration signal based on the haptic parameter.

In a possible embodiment of the present disclosure, the virtual haptic texture rendering method further includes: determining first coordinates of a first touch point of the user in the first coordinate system in the case that the visual image displayed on a display screen is touched by the user; determining second coordinates of the first touch point in the second coordinate system in accordance with the first coordinates and the association relationship between the first coordinate system and the second coordinate system; determining a target grayscale region in which a pixel corresponding to the second coordinates is located; invoking a target haptic parameter corresponding to the target grayscale region, and generating the haptic vibration signal in accordance with the target haptic parameter; and driving the display screen to vibrate at a position corresponding to the first coordinates in accordance with the haptic vibration signal.

In a possible embodiment of the present disclosure, the performing the multi-valued processing on the grayscale image to obtain the haptic response image includes: performing the multi-valued processing on the grayscale image to obtain a multi-valued image; segmenting the multi-valued image into a plurality of pixel regions; and filtering out a target pixel region to obtain the haptic response image. A side length of the target pixel region is smaller than or equal to a first threshold value, and/or an area of the target pixel region is smaller than or equal to a second threshold value.

In a possible embodiment of the present disclosure, the first threshold is 1 mm, and/or the second threshold is 1 mm².

In a possible embodiment of the present disclosure, the performing the multi-valued processing on the grayscale image to obtain the haptic response image includes performing binarization on the grayscale image to obtain the haptic response image, and pixels of the haptic response image are grouped into two grayscale regions of 0 and 255.

In a possible embodiment of the present disclosure, prior to associating the first coordinate system of the visual image with the second coordinate system of the haptic response image, the virtual haptic texture rendering method further includes: displaying a corrected image on a display screen, a touch reference point being displayed on the corrected image; and determining a coordinate difference value between a second touch point of the user and the touch reference point in the case that the corrected image is touched by the user. The associating the first coordinate system of the visual image with the second coordinate system of the haptic response image includes associating the first coordinate system of the visual image with the second coordinate system of the haptic response image in accordance with the coordinate difference value.

In a possible embodiment of the present disclosure, the quantity of the touch reference points is plural, and touch reference points include at least one of a lower-left coordinate point, an upper-left coordinate point, a lower-right coordinate point or an upper-right coordinate point of the corrected image.

In another aspect, the present disclosure provides in some embodiments a virtual haptic texture rendering device, including: a first obtaining module configured to obtain a to-be-displayed visual image; an image conversion module configured to convert the visual image into a grayscale image; a multi-valued processing module configured to perform multi-valued processing on the grayscale image to obtain a haptic response image, all pixels of the haptic response image being grouped into at least two grayscale regions, different haptic parameters corresponding to different grayscale regions; and a coordinate system association module configured to associate a first coordinate system of the visual image with a second coordinate system of the haptic response image to obtain an association relationship between the first coordinate system and the second coordinate system, the association relationship being configured to determine a haptic parameter corresponding to a pixel at a touch point of a user in the case that the visual image is displayed and touched by the user, and generate a haptic vibration signal in accordance with the haptic parameter.

In yet another aspect, the present disclosure provides in some embodiments a display device, including a processor, a memory, and a program stored in the memory and executed by the processor. The program is executed by the processor so as to implement the steps of the above-mentioned virtual haptic texture rendering method.

In still yet another aspect, the present disclosure provides in some embodiments a computer-readable storage medium storing therein a computer program. The computer program is executed by a processor so as to implement the steps of the above-mentioned virtual haptic texture rendering method.

According to the embodiments of the present disclosure, the visual image is converted into the grayscale image, the multi-valued processing is performed on the grayscale image, all the pixels in the haptic response image are grouped into at least two grayscale regions, and different haptic parameters correspond to different grayscale regions. As a result, when the visual image displayed on the display screen is touched by the user, it is able to determine the grayscale region to which the pixel at the touch point belongs in accordance with the coordinates of the touch point, and provide a haptic feedback in accordance with the haptic parameters corresponding to the grayscale region, thereby to achieve the virtual haptic.

### BRIEF DESCRIPTION OF THE DRAWINGS

Through reading the detailed description hereinafter, the other advantages and benefits will be apparent to a person skilled in the art. The drawings are merely used to show the preferred embodiments, but shall not be construed as limiting the present disclosure. In addition, in the drawings, same reference symbols represent same members. In these drawings,

FIG. 1 is a schematic view showing a relationship between an optical reflection image and a surface of an object;

FIG. 2 is a flow chart of a virtual haptic texture rendering method according to one embodiment of the present disclosure;

FIG. 3 is another flow chart of the virtual haptic texture rendering method according to one embodiment of the present disclosure;

FIG. 4 is a schematic view showing a method for dividing grayscale regions according to one embodiment of the present disclosure;

FIG. 5 is a schematic view showing the processing on a visual image according to one embodiment of the present disclosure;

FIG. 6 is a schematic view showing a coordinate system association method according to one embodiment of the present disclosure;

FIG. 7 is a schematic view showing the virtual haptic texture rendering method according to one embodiment of the present disclosure;

FIG. 8 is another schematic view showing the virtual haptic texture rendering method according to one embodiment of the present disclosure;

FIG. 9 is a schematic view showing a virtual haptic texture rendering device according to one embodiment of the present disclosure;

FIG. 10 is another schematic view showing the virtual haptic texture rendering device according to one embodiment of the present disclosure; and

FIG. 11 is a schematic view showing a display device according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

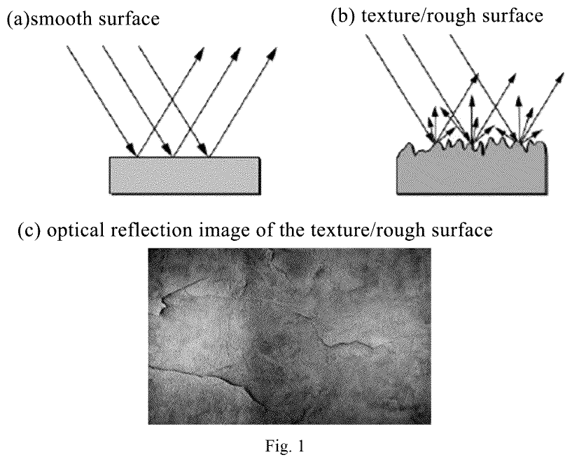

As shown in FIG. 1, light is reflected or refracted by a surface of an object in a different manner depending on its texture or roughness. For example, when the object has a smooth surface, the light is reflected by the smooth surface back to a camera, so bright regions occur in an optical reflection image. When the object has texture or a rough surface, the light is scattered by the texture or rough surface away from the camera, so dark regions occur in the optical reflection image. In the other words, information about a brightness level in the image may be used to reflect the texture or roughness of the surface of the object.

Based on a correspondence between the information about the brightness level in the image and the texture or roughness of the surface of the object, in the embodiments of the present disclosure, a displayed visual image is converted into a grayscale image (grayscale is used to describe a brightness level of the object in the image, and when the visual image is converted into the grayscale image, it is able to extract information about the texture or roughness of the surface of the object in the visual image), multi-valued processing is performed on the grayscale image, all the pixels in a haptic response image are grouped into at least two grayscale regions, and different haptic parameters correspond to different grayscale regions. As a result, when the visual image displayed on the display screen is touched by a user, it is able to determine the grayscale region to which a pixel at a touch point belongs in accordance with coordinates of the touch point, and provide a haptic feedback in accordance with the haptic parameters corresponding to the grayscale region, thereby to achieve the virtual haptics.

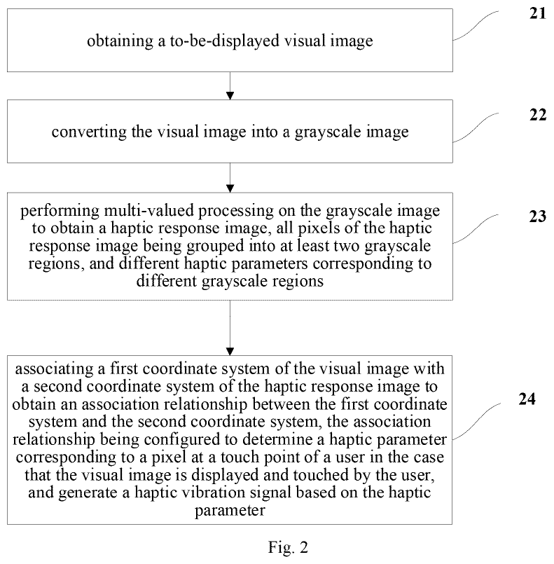

As shown in FIG. 2, the present disclosure provides in some embodiments a virtual haptic texture rendering method, which includes the following steps.

Step 21: obtaining a to-be-displayed visual image.

The visual image is a red-green-blue (RGB) image or any other color image.

Step 22: converting the visual image into a grayscale image.

The visual image is converted into the grayscale image, so as to extract information about texture or roughness of a surface of an object in the visual image.

In the embodiments of the present disclosure, each pixel of the grayscale image is represented with 8 bits (255 grayscale levels) or 16 bits (65536 grayscale levels).

In the embodiments of the present disclosure, the visual image is converted into the grayscale image in various ways, e.g., an averaging method, i.e., obtaining an average value of brightness values of RGB channels of a same pixel, or a maximum-minimum averaging method, i.e., obtaining an average value of a maximum brightness value and a minimum brightness value of the RGB channels of the same pixel, or a weighted-average method, i.e., determining a weighting coefficient of the brightness values of the RGB channels in accordance with a human brightness perception system.

Step 23: performing multi-valued processing on the grayscale image to obtain a haptic response image, all pixels of the haptic response image being grouped into at least two grayscale regions, and different haptic parameters corresponding to different grayscale regions.

For the multi-valued processing, also known as Gaussian brightness processing on the grayscale image, all pixels in the grayscale image are grouped into at least two grayscale regions, and different grayscale regions correspond to different brightness levels (i.e., different texture or roughness). An object of dividing the grayscales into different grayscale regions is to define several haptic vibration signals to be realized. In the embodiments of the present disclosure, the quantity of grayscale regions is the same as the quantity of haptic parameters (i.e., each haptic parameter corresponds to one haptic vibration signal).

The quantity of grayscale regions is set according to the practical need, e.g., the user's demand and hardware complexity of a display device (e.g., a computing capability and a response speed of a Central Processing Unit (CPU)). The more the grayscale regions, the higher the required computing capability.

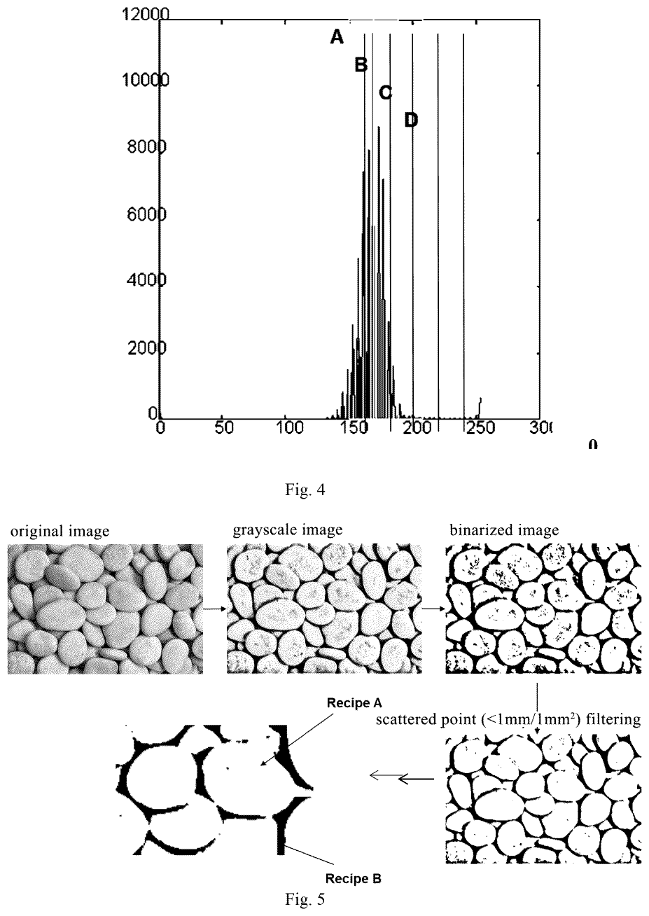

For example, as shown in FIG. 4, all the pixels in the grayscale image are grouped into four grayscale regions (A, B, C, D). In FIG. 4, ab abscissa represents a grayscale value of a pixel, and an ordinate represents the quantity of pixels. As shown in FIG. 4, the grayscale region A represents the pixels with grayscale values within a range of 130 to 150, the grayscale region B represents the pixels with grayscale values within a range of 150 to 170, the grayscale region C represents the pixels with grayscale values within a range of 170 to 190, and the grayscale region D represents the pixels with grayscale values within a range of 190 to 210.

The haptic feedback is generated as follows. An image is viewed and touched by the user, and then a stimulus caused by a force is applied to the user exactly at a touch point (coordinates of the touch point matches those in the image) in such a manner as to conform to the user's psychological experience. Thus, in the embodiments of the present disclosure, the method further includes Step 24 of associating a first coordinate system of the visual image with a second coordinate system of the haptic response image to obtain an association relationship between the first coordinate system and the second coordinate system. The association relationship is configured to determine a haptic parameter corresponding to a pixel of a touch point of a user in the case that the visual image is displayed and touched by the user, and generate a haptic vibration signal in accordance with the haptic parameter.

For example, for the visual image, a lower left corner of the image is taken as a coordinate origin of the first coordinate system, a horizontal direction is an x-axis, and a vertical direction as a y-axis. Identically, for the haptic response image, a lower left corner of the image is taken as a coordinate origin of the second coordinate system, a horizontal direction is an x-axis, and a vertical direction is a y-axis. Coordinates of each pixel in the first coordinate system are associated with coordinates of a corresponding pixel in the second coordinate system.

In the embodiments of the present disclosure, the visual image is converted into the grayscale image, the multi-valued processing is performed on the grayscale image, all the pixels in the haptic response image are grouped into at least two grayscale regions, and different haptic parameters correspond to different grayscale regions. As a result, when the visual image displayed on the display screen is touched by the user, it is able to determine the haptic parameter corresponding to the pixel at the touch point in accordance with the association relationship, generate the haptic vibration signal in accordance with the haptic parameter, and provide a haptic feedback, thereby to achieve the virtual haptics.

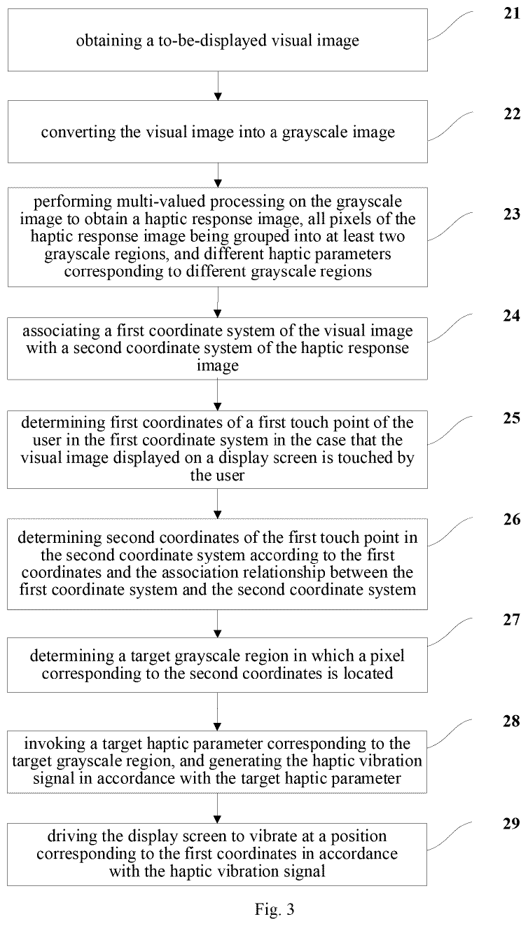

As shown in FIG. 3, in the embodiments of the present disclosure, in addition to the above Steps 21 to 24, the method further includes: Step 25 of determining first coordinates of a first touch point of the user in the first coordinate system in the case that the visual image displayed on a display screen is touched by the user; Step 26 of determining second coordinates of the first touch point in the second coordinate system in accordance with the first coordinates and the association relationship between the first coordinate system and the second coordinate system; Step 27 of determining a target grayscale region in which a pixel corresponding to the second coordinates is located; Step 28 of invoking a target haptic parameter corresponding to the target grayscale region, and generating the haptic vibration signal in accordance with the target haptic parameter; and Step 29 of driving the display screen to vibrate at a position corresponding to the first coordinates in accordance with the haptic vibration signal.

In the embodiments of the present disclosure, when the visual image displayed on the display screen is touched by the user, the coordinates of the touch point in the haptic response image is determined in accordance with the coordinates of the touch point in the visual image, the corresponding haptic parameter is determined in accordance with the grayscale region to which the corresponding pixel in the haptic response image belongs, and then a haptic vibration signal is generated in accordance with the haptic parameter so as to drive the display screen to vibrate. Hence, when the visual image is touched by the user, it is able to provide different haptic feedbacks, thereby to enable the user to feel the texture and roughness of the surface of the object.

In a possible embodiment of the present disclosure, a duration of the haptic vibration signal is smaller than 30 ms.

In a possible embodiment of the present disclosure, the haptic feedback at the touch point on the display screen is achieved through an electrostatic force, a piezoelectric actuator, or mechanical vibration.

In order to reduce a computing burden, in a possible embodiment of the present disclosure, the performing the multi-valued processing on the grayscale image to obtain the haptic response image includes performing binarization on the grayscale image to obtain the haptic response image. Pixels of the haptic response image are grouped into two grayscale regions of 0 and 255.

A width of a human finger is about 15 mm, so it is difficult to distinguish a region that is too small (e.g., a region smaller than 1 mm²). In the embodiments of the present disclosure, after the binarization on the grayscale image, it is able to filter out the region with a smaller area.

In a possible embodiment of the present disclosure, the performing the multi-valued processing on the grayscale image to obtain the haptic response image includes: Step 231 of performing the multi-valued processing on the grayscale image to obtain a multi-valued image; Step 232 of segmenting the multi-valued image into a plurality of pixel regions; and Step 233 of filtering out a target pixel region to obtain the haptic response image. A side length of the target pixel region is smaller than or equal to a first threshold value, and/or an area of the target pixel region is smaller than or equal to a second threshold value.

In a possible embodiment of the present disclosure, the first threshold is 1 mm, and/or the second threshold is 1 mm².

As shown in FIG. 5, at first an original visual image (i.e., an original image in FIG. 5) is converted into a grayscale image, the binarization is performed on the grayscale image to obtain a binarized image, segmentation is performed on the binarized image to obtain a plurality of pixel regions, and then a target pixel region is filtered out to obtain a haptic response image (i.e., the scattered point filtering in FIG. 5). A side length of the target pixel region is smaller than or equal to a first threshold value and/or an area of the target pixel region is smaller than or equal to a second threshold value. The haptic response image includes two grayscale regions (a grayscale region (Recipe) A and a grayscale region (Recipe) B in FIG. 5), a grayscale value of the pixels in the grayscale region (Recipe) A is 0, and a grayscale value of the pixels in the grayscale region (Recipe) B is 255.

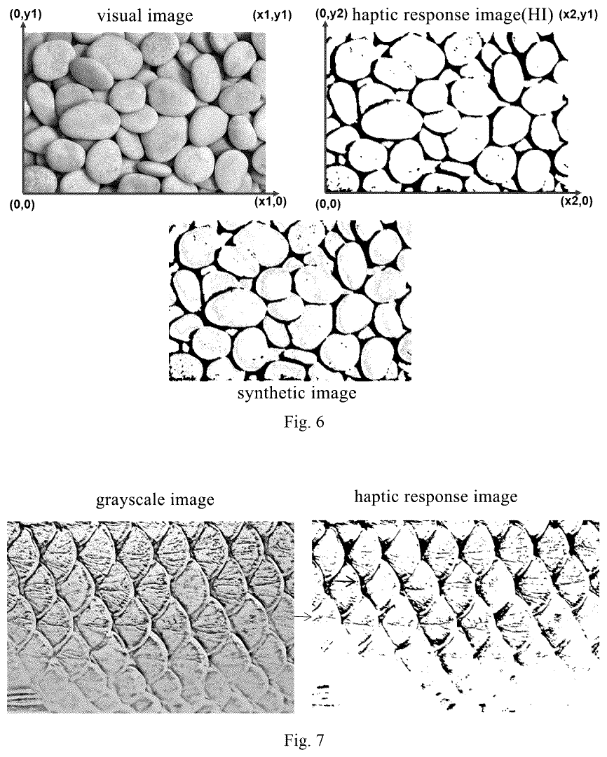

In the embodiments of the present disclosure, when associating the first coordinate system of the visual image with the second coordinate system of the haptic response image in Step 24, as shown in FIG. 6, an origin of the first coordinate system of the visual image coincides with an origin of the second coordinate system of the haptic response image, x1=x2, and y1=y2.

However, when the display screen is touched by the user, the user's visual sense and haptic sense may not occur at a same position due to a touch gesture or user's visual deviation. In order to avoid the visual and haptic deviation caused by the touch gesture or user's visual deviation, in a possible embodiment of the present disclosure, prior to associating the first coordinate system of the visual image with the second coordinate system of the haptic response image, the method further includes: displaying a corrected image on a display screen, a touch reference point being displayed on the corrected image; and determining a coordinate difference value between a second touch point of the user and the touch reference point in the case that the corrected image is touched by the user. The associating the first coordinate system of the visual image with the second coordinate system of the haptic response image includes associating the first coordinate system of the visual image with the second coordinate system of the haptic response image in accordance with the coordinate difference value.

In a possible embodiment of the present disclosure, the quantity of the touch reference points is plural, and touch reference points include at least one of a lower-left coordinate point, an upper-left coordinate point, a lower-right coordinate point or an upper-right coordinate point of the corrected image.

In a possible embodiment of the present disclosure, the coordinate difference value includes an x-axis difference value and a y-axis difference value.

In a possible embodiment of the present disclosure, the corrected image is the visual image, and the touch reference point includes at least one of a lower-left coordinate point (the origin), an upper-left coordinate point, a lower-right coordinate point or an upper-right coordinate point of the visual image, e.g., (0, 0), (x1, 0), (0, y1), (x1, y1) in FIG. 6. The association relationship between the second touch point (x1, y1) and the touch reference point (x2, y2) is presented as x1=x2+a, and y1=y2+b.

In the embodiments of the present disclosure, the selection of the haptic vibration signal depends on a content of the visual image. For example, when the image is bark, the selected haptic parameters include frequency>20 kHz, amplitude>1 Um, modulation<10 Hz. When the image is displayed as glass, a waveform without modulation is selected.

In a possible embodiment of the present disclosure, subsequent to determining the target grayscale region in which the pixel corresponding to the second coordinates is located, the method further includes: invoking a sound control signal corresponding to the target grayscale region; and controlling the display device to make a sound in accordance with the sound control signal. In this way, vision, hearing and haptics are all provided through the display device.

The virtual haptic texture rendering method will be illustratively described hereinafter.

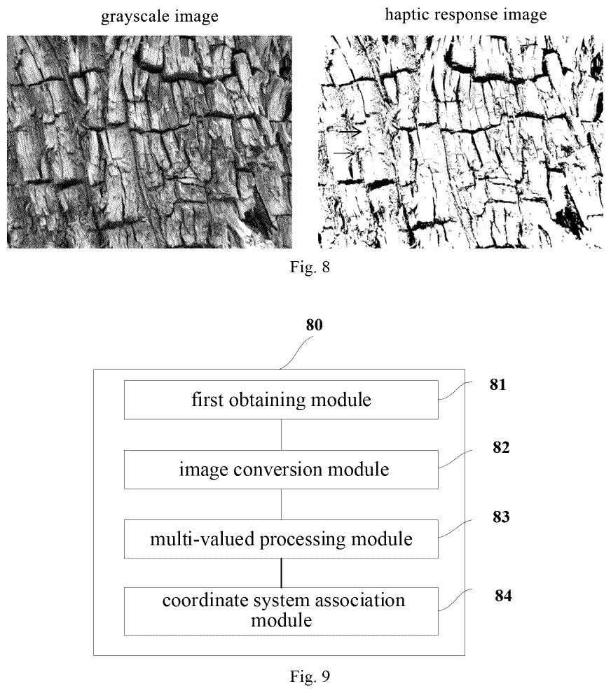

As shown in FIG. 7 and FIG. 8, in the embodiments of the present disclosure, the virtual haptic texture rendering method includes the following steps.

Step 1: obtaining a to-be-displayed visual image.

The visual image is an RGB image.

Step 2: converting the visual image into a grayscale image.

Step 3: performing binarization on the grayscale image, segmenting a resultant binarized image to obtain a plurality of pixel regions, and filtering out a target pixel region to obtain a haptic response image. A side length of the target pixel region is smaller than or equal to a first threshold value and/or an area of the target pixel region is smaller than or equal to a second threshold value. All pixels of the haptic response image are grouped into two grayscale regions, and different haptic parameters correspond to different grayscale regions.

Step 4: associating a first coordinate system of the visual image with a second coordinate system of the haptic response image to obtain an association relationship between the first coordinate system and the second coordinate system. The association relationship is configured to determine a haptic parameter corresponding to a pixel at a touch point of a user in the case that the visual image is displayed and touched by the user, and generate a haptic vibration signal in accordance with the haptic parameter.

Step 5: determining first coordinates of a first touch point of the user in the first coordinate system in the case that the visual image is displayed on a display screen.

Step 6: determining second coordinates of the first touch point in the second coordinate system in accordance with the first coordinate and the association relationship between the first coordinate system and the second coordinate system.

Step 7: determining a target grayscale region in which a pixel corresponding to the second coordinates is located.

Step 8: invoking a target haptic parameter corresponding to the target grayscale region, and generating the haptic vibration signal in accordance with the target haptic parameter.

Step 9: driving the display screen to vibrate at a position corresponding to the first coordinates in accordance with the haptic vibration signal.

According to the embodiments of the present disclosure, when the visual image displayed on the display screen is touched by the user, the coordinates of the pixel corresponding to the touch point in the haptic response image are determined in accordance with the coordinates of the touch point in the visual image, the corresponding haptic parameter is determined in accordance with the grayscale region to which the pixel in the haptic response image belongs, and the haptic vibration signal is generated in accordance with the determined haptic parameters to drive the display screen to vibrate. As a result, when the visual image displayed on the display screen is touched by the user, it is able to provide a haptic feedback in accordance with the haptic parameters corresponding to the grayscale region, thereby to enable the user to feel the texture and the roughness of the object.

As shown in FIG. 9, the present disclosure further provides in some embodiments a virtual haptic texture rendering device 80, which includes: a first obtaining module 81 configured to obtain a to-be-displayed visual image; an image conversion module 82 configured to convert the visual image into a grayscale image; a multi-valued processing module 83 configured to perform multi-valued processing on the grayscale image to obtain a haptic response image, all pixels of the haptic response image being grouped into at least two grayscale regions, different haptic parameters corresponding to different grayscale regions; and a coordinate system association module 84 configured to associate a first coordinate system of the visual image with a second coordinate system of the haptic response image to obtain an association relationship between the first coordinate system and the second coordinate system, the association relationship being configured to determine a haptic parameter corresponding to a pixel at a touch point of a user in the case that the visual image is displayed and touched by the user, and generate a haptic vibration signal in accordance with the haptic parameter.

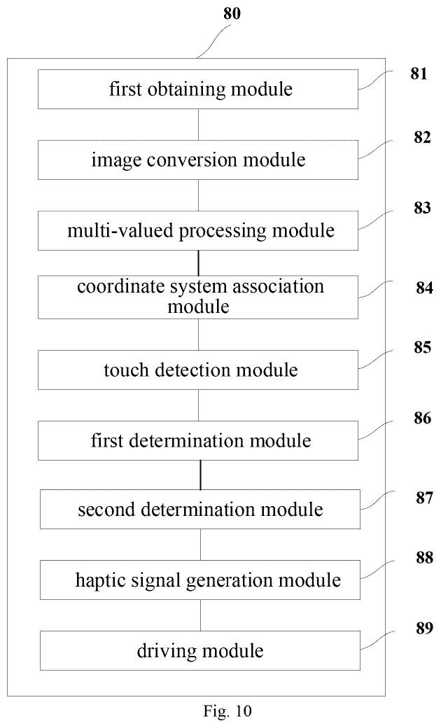

In a possible embodiment of the present disclosure, as shown in FIG. 10, the virtual haptic texture rendering device 80 further includes: a touch detection module 85 configured to determine first coordinates of a first touch point of the user in the first coordinate system in the case that the visual image displayed on a display screen is touched by the user; a first determination module 86 configured to determine second coordinates of the first touch point in the second coordinate system according to the first coordinates and the association relationship between the first coordinate system and the second coordinate system; a second determination module 87 configured to determine a target grayscale region in which a pixel corresponding to the second coordinates is located; a haptic signal generation module 88 configured to invoke a target haptic parameter corresponding to the target grayscale region, and generate the haptic vibration signal in accordance with the target haptic parameter; and a driving module 89 configured to drive the display screen to vibrate at a position corresponding to the first coordinates in accordance with the haptic vibration signal.

In a possible embodiment of the present disclosure, the multi-valued processing module 83 is further configured to: perform the multi-valued processing on the grayscale image to obtain a multi-valued image; segment the multi-valued image into a plurality of pixel regions; and filter out a target pixel region to obtain the haptic response image. A side length of the target pixel region is smaller than or equal to a first threshold value, and/or an area of the target pixel region is smaller than or equal to a second threshold value.

In a possible embodiment of the present disclosure, the first threshold is 1 mm, and/or the second threshold is 1 mm².

In a possible embodiment of the present disclosure, the multi-valued processing module 83 is further configured to perform binarization on the grayscale image to obtain the haptic response image, and pixels of the haptic response image are grouped into two grayscale regions of 0 and 255.

In a possible embodiment of the present disclosure, the virtual haptic texture rendering device 80 further includes a correction module configured to: display a corrected image on a display screen, a touch reference point being displayed on the corrected image; and determine a coordinate difference value between a second touch point of the user and the touch reference point in the case that the corrected image is touched by the user. The coordinate system association module 84 is configured to associate the first coordinate system of the visual image with the second coordinate system of the haptic response image in accordance with the coordinate difference value.

In a possible embodiment of the present disclosure, the corrected image is the visual image.

In a possible embodiment of the present disclosure, the quantity of the touch reference points is plural, and touch reference points include at least one of a lower-left coordinate point, an upper-left coordinate point, a lower-right coordinate point or an upper-right coordinate point of the corrected image.

In a possible embodiment of the present disclosure, the coordinate difference value includes an x-axis difference value and a y-axis difference value.

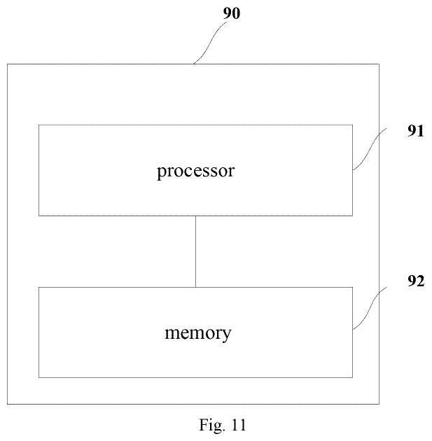

As shown in FIG. 11, the present disclosure further provides in some embodiments a display device 90, including a processor 91, a memory 92, and a computer program stored in the memory 92 and executed by the processor 91. The computer program is executed by the processor 91 so as to implement the steps in the above-mentioned virtual haptic texture rendering method with a same technical effect, which will not be particularly defined herein.

The present disclosure further provides in some embodiments a computer-readable storage medium storing therein a computer program. The computer program is executed by a processor so as to implement the steps in the above-mentioned virtual haptic texture rendering method with a same technical effect, which will not be particularly defined herein. The computer-readable storage medium includes a read-only memory (ROM), a random access memory (RAM), a magnetic disk or an optical disk.

It should be appreciated that, such word as “include” or “including” or any other variations involved in the present disclosure intend to provide non-exclusive coverage, so that a procedure, method, article or device including a series of elements may also include any other elements not listed herein, or may include any inherent elements of the procedure, method, article or device. If without any further limitations, for the elements defined by such sentence as “including one . . . ”, it is not excluded that the procedure, method, article or device including the elements may also include any other identical elements.

Through the above description, a person skilled in the art may clearly understand that the methods in the above embodiments may be implemented by means of software and a necessary general hardware platform. Based on this, the technical solutions of the present disclosure, partial or full, or parts of the technical solutions of the present disclosure contributing to the related art, may appear in the form of software products, which may be stored in a storage medium (such as an ROM/RAM, a magnetic disk or an optical disk) and include several instructions so as to enable a terminal (a mobile phone, a computer, a server, an air conditioner, or a network device) to execute all or parts of the steps of the method according to the embodiments of the present disclosure.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. A virtual haptic texture rendering method, comprising:
obtaining a to-be-displayed visual image;
converting the visual image into a grayscale image;
performing multi-valued processing on the grayscale image to obtain a haptic response image, all pixels of the haptic response image being grouped into at least two grayscale regions, and different haptic parameters corresponding to different grayscale regions; and
associating a first coordinate system of the visual image with a second coordinate system of the haptic response image to obtain an association relationship between the first coordinate system and the second coordinate system, the association relationship being configured to determine a haptic parameter corresponding to a pixel at a touch point of a user in the case that the visual image is displayed and touched by the user, and generate a haptic vibration signal based on the haptic parameter.

2. The virtual haptic texture rendering method according to claim 1, further comprising:
determining first coordinates of a first touch point of the user in the first coordinate system in the case that the visual image displayed on a display screen is touched by the user;
determining second coordinates of the first touch point in the second coordinate system according to the first coordinates and the association relationship between the first coordinate system and the second coordinate system;
determining a target grayscale region in which a pixel corresponding to the second coordinates is located;
invoking a target haptic parameter corresponding to the target grayscale region, and generating the haptic vibration signal in accordance with the target haptic parameter; and
driving the display screen to vibrate at a position corresponding to the first coordinates in accordance with the haptic vibration signal.

3. The virtual haptic texture rendering method according to claim 1, wherein the performing the multi-valued processing on the grayscale image to obtain the haptic response image comprises:
performing the multi-valued processing on the grayscale image to obtain a multi-valued image;
segmenting the multi-valued image into a plurality of pixel regions; and
filtering out a target pixel region to obtain the haptic response image,
wherein a side length of the target pixel region is smaller than or equal to a first threshold value, and/or an area of the target pixel region is smaller than or equal to a second threshold value.

4. The virtual haptic texture rendering method according to claim 3, wherein the first threshold is 1 mm, and/or the second threshold is 1 mm².

5. The virtual haptic texture rendering method according to claim 1, wherein the performing the multi-valued processing on the grayscale image to obtain the haptic response image comprises performing binarization on the grayscale image to obtain the haptic response image, and pixels of the haptic response image are grouped into two grayscale regions of 0 and 255.

6. The virtual haptic texture rendering method according to claim 1, wherein prior to associating the first coordinate system of the visual image with the second coordinate system of the haptic response image, the virtual haptic texture rendering method further comprises:
displaying a corrected image on a display screen, a touch reference point being displayed on the corrected image; and
determining a coordinate difference value between a second touch point of the user and the touch reference point in the case that the corrected image is touched by the user,
wherein the associating the first coordinate system of the visual image with the second coordinate system of the haptic response image comprises associating the first coordinate system of the visual image with the second coordinate system of the haptic response image in accordance with the coordinate difference value.

7. The virtual haptic texture rendering method according to claim 6, wherein the corrected image is the visual image.

8. The virtual haptic texture rendering method according to claim 6, wherein the quantity of the touch reference points is plural, and touch reference points comprise at least one of a lower-left coordinate point, an upper-left coordinate point, a lower-right coordinate point or an upper-right coordinate point of the corrected image.

9. A virtual haptic texture rendering device, comprising:
a first obtaining module configured to obtain a to-be-displayed visual image;
an image conversion module configured to convert the visual image into a grayscale image;
a multi-valued processing module configured to perform multi-valued processing on the grayscale image to obtain a haptic response image, all pixels of the haptic response image being grouped into at least two grayscale regions, different haptic parameters corresponding to different grayscale regions; and
a coordinate system association module configured to associate a first coordinate system of the visual image with a second coordinate system of the haptic response image to obtain an association relationship between the first coordinate system and the second coordinate system, the association relationship being configured to determine a haptic parameter corresponding to a pixel at a touch point of a user in the case that the visual image is displayed and touched by the user, and generate a haptic vibration signal in accordance with the haptic parameter.

10. A display device, comprising a processor, a memory, and a program stored in the memory and executed by the processor, wherein the processor is configured to read the program so as to:
obtain a to-be-displayed visual image;
convert the visual image into a grayscale image;
perform multi-valued processing on the grayscale image to obtain a haptic response image, all pixels of the haptic response image being grouped into at least two grayscale regions, and different haptic parameters corresponding to different grayscale regions; and
associate a first coordinate system of the visual image with a second coordinate system of the haptic response image to obtain an association relationship between the first coordinate system and the second coordinate system, the association relationship being configured to determine a haptic parameter corresponding to a pixel at a touch point of a user in the case that the visual image is displayed and touched by the user, and generate a haptic vibration signal based on the haptic parameter.

11. A computer-readable storage medium storing therein a computer program, wherein the computer program is executed by a processor so as to implement the steps of the virtual haptic texture rendering method according to claim 1.

12. The virtual haptic texture rendering method according to claim 7, wherein the quantity of the touch reference points is plural, and touch reference points comprise at least one of a lower-left coordinate point, an upper-left coordinate point, a lower-right coordinate point or an upper-right coordinate point of the corrected image.

13. The display device according to claim 10, wherein the processor is configured to read the program, so as to:
determine first coordinates of a first touch point of the user in the first coordinate system in the case that the visual image displayed on a display screen is touched by the user;
determine second coordinates of the first touch point in the second coordinate system according to the first coordinates and the association relationship between the first coordinate system and the second coordinate system;
determine a target grayscale region in which a pixel corresponding to the second coordinates is located;
invoke a target haptic parameter corresponding to the target grayscale region, and generate the haptic vibration signal in accordance with the target haptic parameter; and
drive the display screen to vibrate at a position corresponding to the first coordinates in accordance with the haptic vibration signal.

14. The display device according to claim 10, wherein when performing the multi-valued processing on the grayscale image to obtain the haptic response image, the processor is configured to read the program, so as to:
perform the multi-valued processing on the grayscale image to obtain a multi-valued image;
segment the multi-valued image into a plurality of pixel regions; and
filter out a target pixel region to obtain the haptic response image,
wherein a side length of the target pixel region is smaller than or equal to a first threshold value, and/or an area of the target pixel region is smaller than or equal to a second threshold value.

15. The display device according to claim 14, wherein the first threshold is 1 mm, and/or the second threshold is 1 mm2.

16. The display device according to claim 10, wherein when performing the multi-valued processing on the grayscale image to obtain the haptic response image, the processor is configured to read the program so as to perform binarization on the grayscale image to obtain the haptic response image, and pixels of the haptic response image are grouped into two grayscale regions of 0 and 255.

17. The display device according to claim 10, wherein prior to associating the first coordinate system of the visual image with the second coordinate system of the haptic response image, the processor is further configured to read the program, so as to:
display a corrected image on a display screen, a touch reference point being displayed on the corrected image; and
determine a coordinate difference value between a second touch point of the user and the touch reference point in the case that the corrected image is touched by the user,
wherein when associating the first coordinate system of the visual image with the second coordinate system of the haptic response image, the processor is configured to read the program so as to associate the first coordinate system of the visual image with the second coordinate system of the haptic response image in accordance with the coordinate difference value.

18. The display device according to claim 17, wherein the corrected image is the visual image.

19. The display device according to claim 17, wherein the quantity of the touch reference points is plural, and touch reference points comprise at least one of a lower-left coordinate point, an upper-left coordinate point, a lower-right coordinate point or an upper-right coordinate point of the corrected image.

20. The display device according to claim 18, wherein the quantity of the touch reference points is plural, and touch reference points comprise at least one of a lower-left coordinate point, an upper-left coordinate point, a lower-right coordinate point or an upper-right coordinate point of the corrected image.
